(19) United States
(12) Patent Application Publication
(10) Pub. No.: US 2021/0241400 A1
(43) Pub. Date: Aug. 5, 2021

(54) SMART CONTRACT IMPLEMENTATION MECHANISMS

(71) Applicant: KINDESTX, LLC, Wilmington, DE (US)

(72) Inventors: Christopher Michael Carthy, Carmel, CA (US); John Ellis Stafira, Dallas, TX (US); Joshua Mitchell Povsner, Ashburn, VA (US)

(21) Appl. No.: 17/161,739

(22) Filed: Jan. 29, 2021

Related U.S. Application Data
(60) Provisional application No. 62/968,574, filed on Jan. 31, 2020.

(51) Int. Cl. G06Q 50/18; G06Q 10/10

(52) U.S. Cl. CPC G06Q 50/18; G06Q 10/10

(57) ABSTRACT

A method for completing a smart contract includes generating, by a smart contract application installed on a first user device, a proposal for a smart contract. The method also includes creating a set of parameter options for completing the smart contract and displaying the set of parameter options via the first user device. The method further includes transmitting, by the first user device, the proposal for the smart contract to a set of second user devices specified by the parameter options. The method also includes completing the smart contract by the smart contract application installed on the first user device and notifying each of the second user devices, only when required parameters in the parameter options are met.

This U.S. nonprovisional patent application claims the benefit of priority to Provisional U.S. Patent Application No. 62/968,574, filed on Jan. 31, 2020 in the United States Patent and Trademark Office, the contents of which are herein incorporated by reference in their entirety.

### BACKGROUND

Smart contracts are contracts automatically implemented by computers based on executable code in a predetermined computer protocol. The smart contracts facilitate completion of contracts between two parties without involving third parties. To date, smart contracts have typically been used for transferring digital currencies or assets. Once completed, the smart contracts are stored in distributed ledger such as versions of blockchain stored by blockchain nodes in a blockchain network and cannot be changed.

The potential for smart contracts to be expanded into additional areas has not been fully explored or developed. For example, smart contracts have not yet been used to serve as a predicate for generating tokens (electronic tokens) for assignment to the two parties, let alone for larger groups of parties, involved in an agreement. The possibility of expanding the use of smart contracts into new areas requires new technologies such as those described hereinbelow.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 illustrates a progression for smart contract implementation mechanisms, in accordance with a representative embodiment.

FIG. 2A illustrates communication linkages for smart contract implementation mechanisms, in accordance with a representative embodiment.

FIG. 2B illustrates a user interface for smart contract implementation mechanisms, in accordance with a representative embodiment.

FIG. 3A illustrates a method for smart contract implementation mechanisms, in accordance with a representative embodiment.

FIG. 3B illustrates another user interface for smart contract implementation mechanisms, in accordance with a representative embodiment.

FIG. 4A illustrates another method for smart contract implementation mechanisms, in accordance with a representative embodiment.

FIG. 4B illustrates another user interface for smart contract implementation mechanisms, in accordance with a representative embodiment.

FIG. 5A illustrates a user interface for a recipient of a proposal in smart contract implementation mechanisms, in accordance with a representative embodiment.

FIG. 5B illustrates a user interface for an originator of a proposal in smart contract implementation mechanisms, in accordance with a representative embodiment.

FIG. 6 illustrates a computer system, on which a method for implementing smart contract implementation mechanisms is implemented, in accordance with a representative embodiment.

FIG. 7 illustrates a network for implementing smart contract implementation mechanisms, in accordance with a representative embodiment.

### DETAILED DESCRIPTION

In the following detailed description, for purposes of explanation and not limitation, representative embodiments disclosing specific details are set forth in order to provide a thorough understanding of an embodiment according to the present teachings. Descriptions of known systems, devices, materials, methods of operation and methods of manufacture may be omitted so as to avoid obscuring the description of the representative embodiments. Nonetheless, systems, devices, materials and methods that are within the purview of one of ordinary skill in the art are within the scope of the present teachings and may be used in accordance with the representative embodiments. It is to be understood that the terminology used herein is for purposes of describing particular embodiments only and is not intended to be limiting. The defined terms are in addition to the technical and scientific meanings of the defined terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure.

The terminology used herein is for purposes of describing particular embodiments only and is not intended to be limiting. As used in the specification and appended claims, the singular forms of terms ‘a’, ‘an’ and ‘the’ are intended to include both singular and plural forms, unless the context clearly dictates otherwise. Additionally, the terms “comprises”, and/or “comprising,” and/or similar terms when used in this specification, specify the presence of stated features, elements, and/or components, but do not preclude the presence or addition of one or more other features, elements, components, and/or groups thereof. As used herein, the term “and/or” includes any and all combinations of one or more of the associated listed items.

Unless otherwise noted, when an element or component is said to be “connected to”, “coupled to”, or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

In view of the foregoing, the present disclosure, through one or more of its various aspects, embodiments and/or specific features or sub-components, is thus intended to bring out one or more of the advantages as specifically noted below. For purposes of explanation and not limitation, example embodiments disclosing specific details are set forth in order to provide a thorough understanding of an embodiment according to the present teachings. However, other embodiments consistent with the present disclosure that depart from specific details disclosed herein remain within the scope of the appended claims. Moreover, descriptions of well-known apparatuses and methods may be omitted so as to not obscure the description of the example embodiments. Such methods and apparatuses are within the scope of the present disclosure.

The teachings herein are related to U.S. Provisional Patent Application No. 62/963,907, filed on Jan. 21, 2020, the disclosure of which is incorporated herein by reference in its entirety. The teachings described in U.S. Provisional Patent Application No. 62/963,907 include descriptions of how digital currencies of various types may be systematically repurposed for specific purposes such as for transaction mediums to which royalties may be allocated. The implementation of smart contracts described herein may be provided using repurposed digital currencies described in U.S. Provisional Patent Application No. 62/963,907, and accordingly, the contents of U.S. Provisional Patent Application No. 62/963,907 are incorporated herein to the extent they are consistent with and can be integrated with the teachings specifically set forth below.

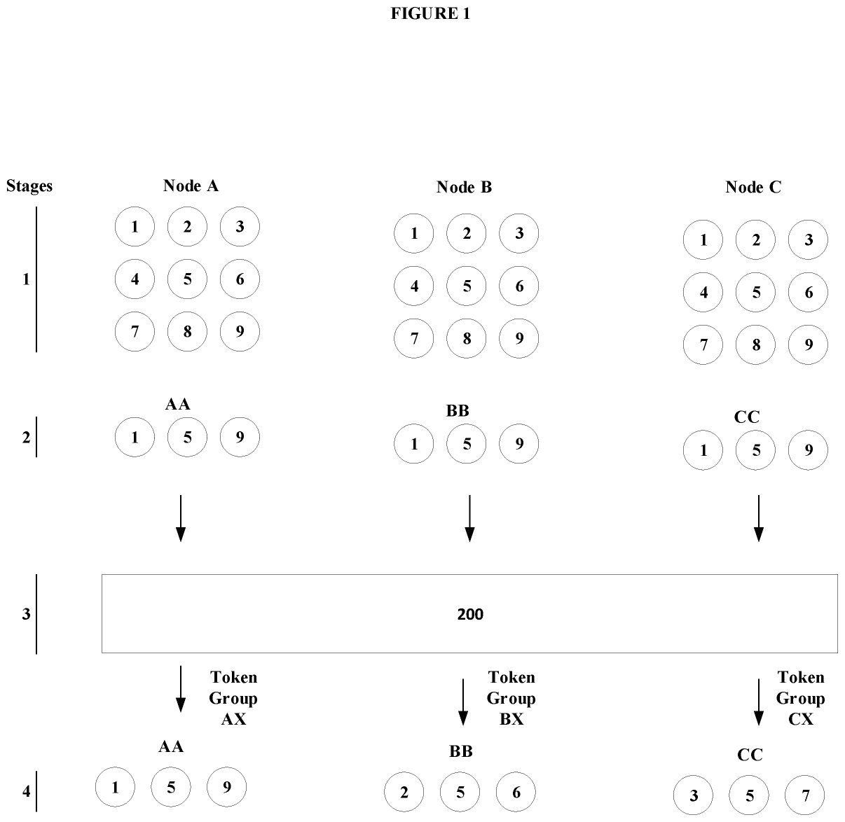

FIG. 1 illustrates a progression for smart contract implementation mechanisms, in accordance with a representative embodiment.

In FIG. 1, a first stage of the progression includes Node A, Node B, and Node C. Each of the three nodes respectively includes nine user devices 1-9 corresponding to nine different users. To be sure, the number of nodes is not limited to three, the number of user devices in any node is not limited to nine, and no user is necessarily limited to a single user device. For example, a single association of researchers or an employer of scientists and engineers may be the source of dozens of nodes. Additionally, different nodes may have different numbers of user devices. For example, one node at or within an entity may have thousands of user devices and another node at or within the same entity may have three user devices. Each user device in FIG. 1 may have installed thereon a smart contract application, and each user device and each instantiation of the smart contract application may be uniquely identified by unique identifications such as device identifications and application identifications.

The nodes in FIG. 1 are created out of a larger population of user devices that have the smart contract application installed thereon. The nodes are created when one of the user devices in the larger population selectively sends a proposal to other devices in the larger population. The user devices in any node include the user device that sends the proposal as a first user device and the user devices that receive the proposal as second user devices. The user devices in a node may have, but do not necessarily have, a direct relationship with one or more other user devices in the node prior to being clustered in the node. The larger population in which proposals may be sent is not limited to a single entity such as an association or employer and may instead extend across entities. For example, the larger population in which proposals may be sent may be the population of user devices on which the smart contract application is installed. The application may include a search function that allows a user to search for other users who meet specified parameters, such as oncology researchers who hold a PhD and who have been named on at least one issued patent. The application may allow the user to select users meeting search functions for invitations to join or apply to join a node.

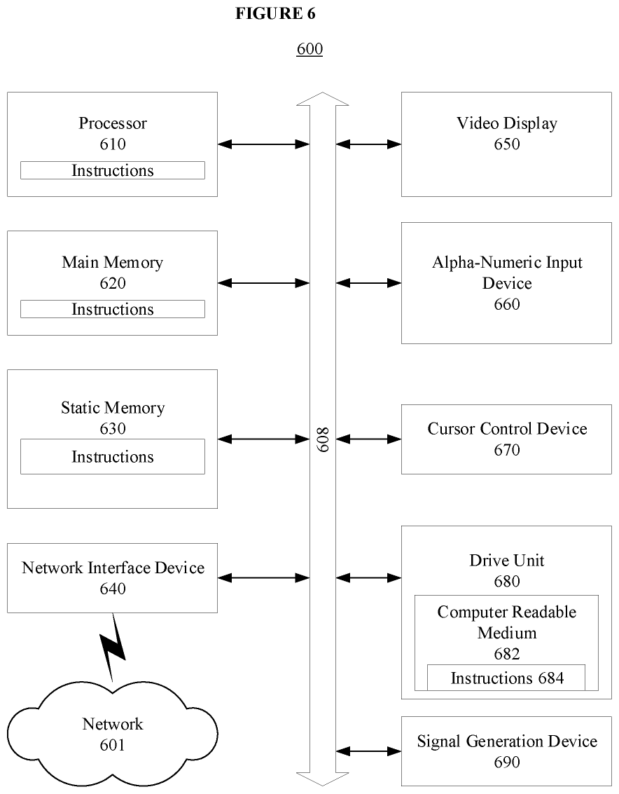

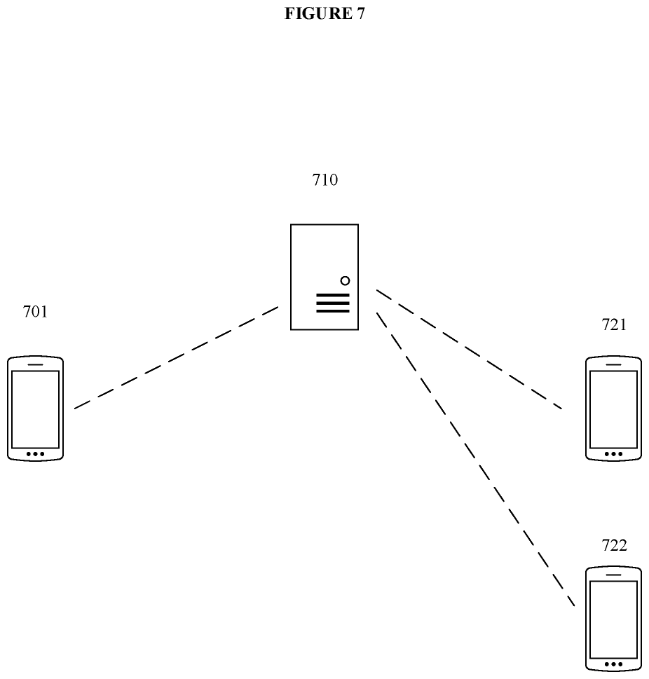

Examples of the user devices in FIG. 1 include smartphones, tablet computers, laptop computers, desktop computers, or other types of electronic devices configured to execute instructions and communicate over electronic communications networks. Each of the set of user devices in FIG. 1 may include a memory that stores instructions and a processor that executes the instructions, and generally may include some or all of the components, characteristics and functionality described with respect to user devices in related U.S. Provisional Patent Application No. 62/963,907. An example of a user device as in FIG. 1 is shown in and described with respect to the computer system 600 in FIG. 6. Additionally, a network organized for communications between user devices as in FIG. 1 is shown in and described with respect to FIG. 7.

A second stage of the progression in FIG. 1 includes derived Node AA, derived Node BB and derived Node CC. Derived Node AA is derived from node A and includes three of the nine user devices from Node A. Derived Node BB is derived from node B and includes three of the nine user devices from Node B. Derived Node CC is derived from node C and includes three of the nine user devices from Node C. The user devices in the derived nodes in FIG. 1 are clustered together in the derived nodes when one of the user devices in a node sends a proposal for a smart contract to the other devices to create the node, and some or all of the recipients of the proposal accept the proposal so as to create the derived node. The derived node includes the sending user device and the accepting user devices.

In some embodiments, the proposal may include a time limit in which recipients that accept the proposal may withdraw acceptance. The proposal may also include an initial time limit for recipients to initially accept the proposal as one of a set of parameter options for completing the smart contract. In some embodiments, the recipients of the proposal may be provided running information of who the other recipients are and whether and when they accept the proposal, as well as terms of the proposal that differ for different recipients. The smart contract may be considered completed when agreement is reached and confirmed, such as when the set of parameter options are met. In other words, completion of the smart contract does not mean that all requirements under the smart contract have been completed; rather, parties subject to the smart contract may be subject to terms of the smart contract going forward even after the smart contract itself is completed.

A third stage of the progression in FIG. 1 includes a transaction network 200. Transaction networks are described in related U.S. Provisional Patent Application No. 62/963,907, the contents of which are incorporated by reference herein in their entirety. The transaction network 200 creates a first unique set of tokens as Token Group AX for derived Node AA, a second unique set of tokens as Token Group BX for derived Node BB, and a third unique set of tokens as Token Group CX for derived node CC. A unique set of tokens may be created by taking an existing set of tokens and uniquely marking each of the tokens in the set with a unique mark in, on or with the tokens and/or in records in the versions of a blockchain maintained by a blockchain network that records transactions involving the tokens. Alternatively, a unique set of tokens may be newly generated by the transaction network 200. In embodiments herein, the unique sets of tokens may be created specifically based on the completion of a smart contract at the second stage of the progression in FIG. 1.

As an example use of the nodes, the derived nodes and the tokens described herein, a user device used by a coordinator coordinating a project may create and send a proposal to user devices of researchers to create a node. The proposal may be to coordinate an effort to reach a particular target, such as a cure for cancer. The coordinator who sends the proposal and the researchers who accept the proposal are placed in the derived node when all initial requirements for implementing (e.g., starting) the project are met. The tokens may be issued to the members of the derived node to reflect ownership interest in royalties or other income streams that result from the project. The details of ownership and rights may be included in the original proposal. As described herein and in related U.S. Provisional Patent Application No. 62/963,907, the tokens may be transactable on an electronic network, such as via an electronic exchange. However, smart contracts for derived nodes described herein are not limited to business or financial contracts and may be used to establish defined relationships in any number of contexts.

In a fourth stage of the progression in FIG. 1, the unique sets of tokens are provided to derived Node AA, derived Node BB, and derived Node CC. The unique set of tokens may reflect ownership interests established by the smart contracts completed in the second stage in FIG. 1 and may be transactable electronically in a peer-to-peer network or via an electronic exchange. The unique marking provided for each set of tokens may allow the tokens to be individually priced by the market. Additionally, the unique sets of tokens may be tracked by an issuer responsible for issuing the tokens, so that transactions involving the tokens are reported back to the issuer or a designee.

As an example use of smart contract implementation mechanisms, a first user device among the first Node A may use a smart contract application installed on the first user device to generate a proposal for a smart contract in the first stage of FIG. 1. The smart contract application may be used to create a set of parameter options for completing the smart contract, and the set of parameter options may be part of the proposal sent in order to create a node in the first stage of FIG. 1. The set of parameter options may be displayed on and selected via the first user device. The first user device may then transmit the proposal for the smart contract to the set of second user devices specified by the parameter options. A first user device and a set of second user devices may be the complete set of user devices 1-9 in any of Node A, Node B or Node C at the first stage of the progression in FIG. 1. The smart contract may be completed only when required parameters in the parameter options are met. The smart contract may be completed by the smart contract application installed on the first user device, and the first user device may notify each of the second user devices of the completion of the smart contract.

The first derived Node AA may include a set of user devices that satisfy one or more of the required parameters in the parameter options of a proposal sent to create node A. The second derived Node BB may include a set of user devices that satisfy one or more of the required parameters in the parameter options of a proposal sent to create node B. The third derived Node CC may include a set of user devices that satisfy one or more of the required parameters in the parameter options of a proposal sent to create node C. Such required parameters may include parameter options such as a minimum number of user devices that accept the proposal, one or more specific user devices that must accept the proposal, and/or one or more combinations of specific user devices that must accept the proposal. The parameter options may also include each of the user devices selected to be in the second set of user devices. For example, a user of the first user device in any set may be presented with a set of contacts, potential contacts, and/or other users of the smart contract application who may be interested in the proposal. In some examples, potential recipients are not shown to be available for a smart contract proposal due to involvement in an existing smart contract. In another example, a user may voluntarily designate that they are unavailable for new proposals for smart contracts generally, or for smart contract proposals of particular types such as job offers. The user of the first user device may select the set of second user devices to receive the proposal and select additional parameter options for the proposal. Parameter options may also include a time limit for required parameters to be met before the proposal is rendered void if not all required parameters are met. Therefore, a method of implementing a smart contract may include setting a time limit for a number of required affirmative responses as one of the required parameters, and then closing the smart contract when the time limit expires.

Although not shown in FIG. 1, recipients of a proposal who provide an affirmative answer may be subject to heightened verification methods. For example, recipients joining a smart contract may be required to provide a fingerprint or thumbprint in order to confirm their affirmative answer. Recipients may also be subject to multi-factor authentication requiring confirmation with secondary user devices, passwords, personal identification numbers (PINs), voice samples, and other forms of heightened verification. The heightened verification may be selectively implemented, such as at the designation of the originator of a proposal or based on the subject matter (e.g., monetary amounts) of the smart contract.

Accordingly, basic requirements of a smart contract can be fulfilled by users of the smart contract application, though the embodiment in FIG. 1 may be considered a simplification compared to other instantiations described herein. Additionally, one result of the fulfillment of the smart contracts described herein may be the assignment of a unique set of tokens for the parties to the unique contract. However, fulfillment of the smart contracts may be followed by additional and/or alternative actions. As described herein, a unique set of tokens may be assigned to participants in a smart contract. The unique set of tokens are electronic tokens such as blockchain transaction mediums derived from and based on an underlying cryptocurrency, and the unique set of tokens may then be exchangeable via an online exchange.

In some embodiments, the smart contract may be automatically completed without further instructions from a user of the first user device after the set of parameter options are completed. For example, receipt of affirmative responses from required user devices among the second user devices may be enough for the smart contract application to automatically complete the contract. Automatic completion may also be based on detecting and confirming affirmative responses via different modes of communication, different communication devices, and different accounts for recipients. For example, answers to a proposal from recipients may be required from a messaging account of a social media provider and a messaging account of a communication service provider.

In some embodiments, recipients corresponding to different of the second user devices may be assigned different weightings, and a sum of affirmative answers reflects different weights for different of the affirmative answers. For example, in an example, an individual recipient using a user device U in the second set may be assigned a weighting of 2.25, and five other individual recipients using user devices V, W X, Y and Z in the second set may be assigned weightings of 0.75. If a required sum among the recipients using user devices in the set of second user devices is 3, then the individual recipient using the user device U combined with even just one of the five other individual recipients using the five other user devices V, W, X, Y and Z may be enough to complete the smart contract by responding in the affirmative.

In some embodiments, a number of affirmative responses that are accepted as one of the required parameters may be limited. For example, the number or weighted-number of affirmative responses that are accepted may be limited to three. In other embodiments, if not enough affirmative responses are received, an initial proposal may be cancelled and a subsequent proposal generated. The subsequent proposal may be sent to the second user devices that responded affirmatively to the initial proposal but not the second user devices that did not respond or that responded negatively. The subsequent proposal may also be sent to additional recipients who did not receive the initial proposal.

In some embodiments, the first user device and the second user devices may communicate in a peer-to-peer network via the smart contract application. For example, a peer-to-peer network may include the first user device and the second user devices. The first user device and the second user device may communicate without coordination by or interaction with any application server or other server that coordinates or interacts with the smart contract application.

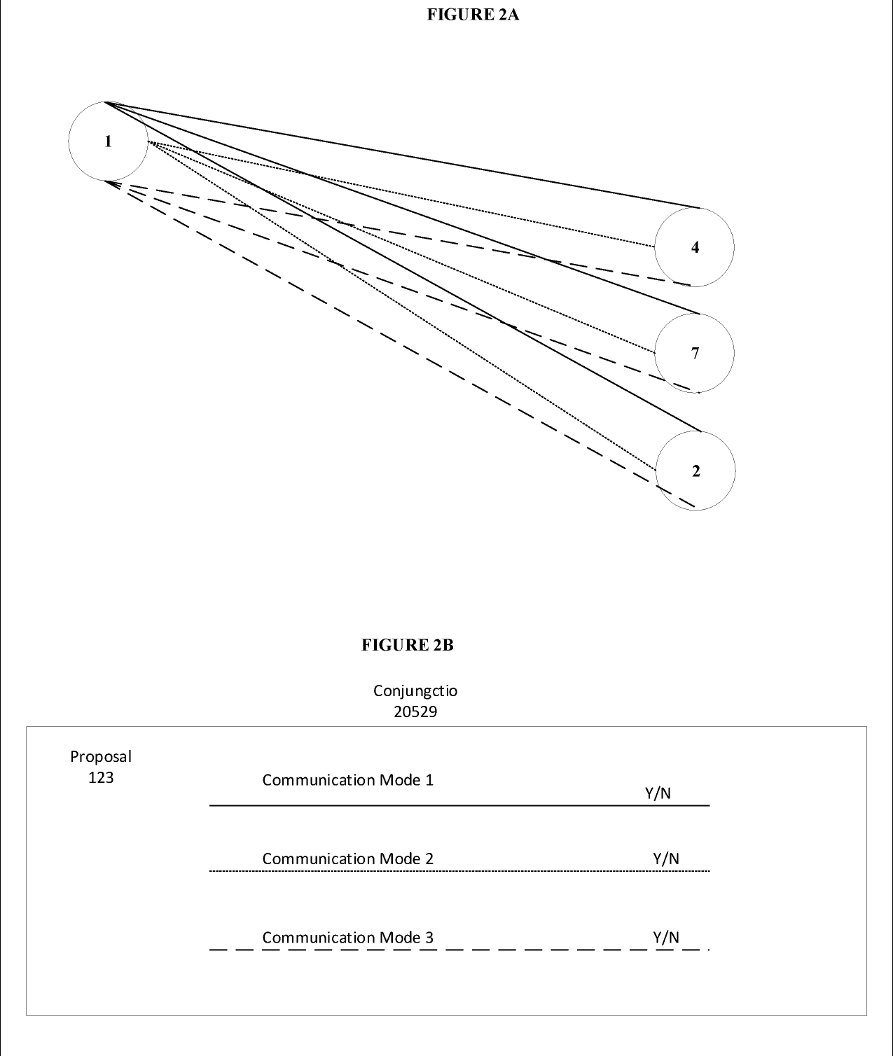

FIG. 2A illustrates communication linkages for smart contract implementation mechanisms, in accordance with a representative embodiment.

In FIG. 2A, a first user device is shown connected to each of three second user devices by three different communication links. The different communication links are represented by a solid line, and two differently broken lines. The different communication links in FIG. 2A may represent different modes of communication, different transmission mediums, different accounts used for the communications, and other differentiable characteristics of communication links. The communication links may include a messaging link, an email link, and a phone link, as examples, though more than one communication link between user devices may be from different accounts for similar types of communications such as messaging. Each of the user devices in any node in FIG. 1 such as Node A, Node B and Node C, may be linked by three or more different communication links with each other user device in the same node. As described, required parameters may include requirements that confirmation of a proposal for a smart contract be provided via more than one communication mode, communication device and/or communication account.

In some embodiments consistent with the descriptions herein, creating a set of parameter options to generate Node A, Node B or Node C as in FIG. 1 may include providing requirements for different modes of communication as shown in FIG. 2A. For example, a set of parameter options created by/at a first user device may include a requirement that each acceptance be provided by two or three different modes of communication such as text, email, phone call, short messaging system (SMS) message, and so on. In some embodiments, creating a set of parameter options to generate Node A, Node B or Node C as in FIG. 1 may include providing optional requirements for different communication devices. For example, a set of parameter options may include a requirement that each acceptance be provided by a smart phone, a tablet computer and/or a desktop computer. In some embodiments, creating a set of parameter options to generate Node A, Node B or Node C as in FIG. 1 may include providing requirements for different accounts for recipients at different ones of the second user devices. For example, a set of parameter options may include a requirement that each acceptance be provided by a first messaging system provided by a wireless carrier, and by a second messaging system provided by a social media provider.

In some embodiments, the first user device and the second user devices may communicate in multiple communication modes. For example, the first user device and the second user devices may communicate by a 4G LTE network or 5G network, a WiFi network, via a wireless service provider's messaging service, via a social network provider's messaging service, via email, and/or via phone calls including voice-over-IP (VoIP) phone calls.

FIG. 2B illustrates a user interface for smart contract implementation mechanisms, in accordance with a representative embodiment.

In FIG. 2B, a smart contract application named “Conjungctio” may be used to implement smart contracts. The user interface 20529 shows a proposal 123 for a smart contract and selectable options of Communication Mode 1, Communication Mode 2, and Communication Mode 3 as potential requirements for affirmative responses from recipients of the proposal 123 in order to complete the smart contract. A user of the first user device that generates the proposal may select any combination of one or more of Communication Mode 1, Communication Mode 2 and Communication Mode 3 as requirements for an affirmative answer from any of the set of second user devices in order to complete the smart contract.

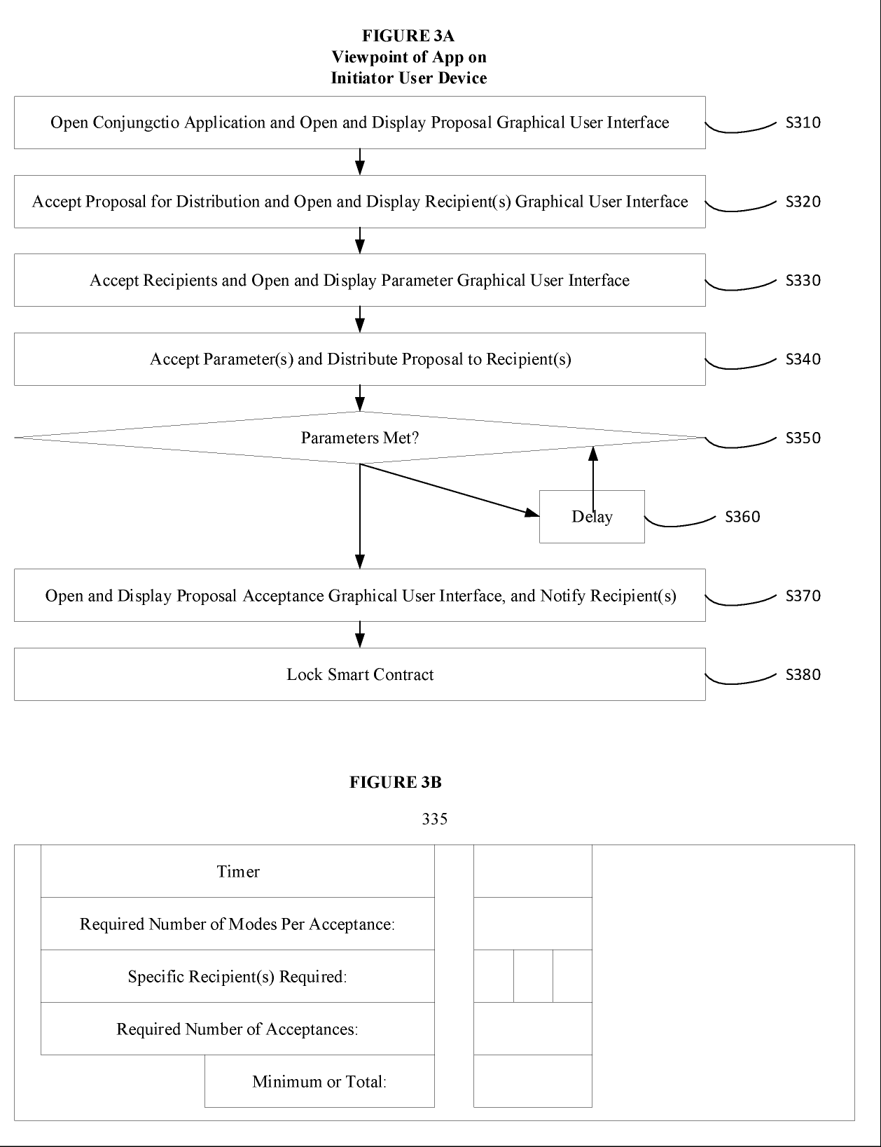

FIG. 3A illustrates a method for smart contract implementation mechanisms, in accordance with a representative embodiment.

In FIG. 3A, the method starts at S310 with opening an instantiation of the Conjungctio application on a user device and opening and displaying a proposal graphical user interface. For example, a default user interface upon opening the Conjungctio application may include a selectable option for opening and displaying a proposal graphical user interface.

At S320, a proposal is accepted for distribution, and a recipient(s) graphical user interface is opened and displayed. The recipient(s) graphical user interface may allow a user to search for and select recipients for a proposal for a smart contract. The recipients displayed to the user may be displayed logically based on previous smart contract activities, relationships with the user, similar interests as the user, and any of a multitude of other types of information that may be used to match a user making a proposal for a smart contract and potential recipients for the proposal. The Conjungctio application may include search functionality that allows a user to search for specific parameters using free-form inquiries and/or using topical parameters such as topics indicatable by checkboxes. The potential recipients may be limited to users who have installed the smart contract Conjungctio application on one or more user devices. Additionally, the user may be provided an ability to define the universe of users who may meet a search, such as by requiring that matches be users who either know (e.g., are already connected on Conjungctio to) the user on Conjungctio or who know somebody who knows (e.g., are connected in common on Conjungctio to somebody who knows) the user.

At S330, the selection of recipients is accepted, and a parameter graphical user interface is opened and displayed. For example, selectable parameter options may include a required number of recipients who respond affirmatively, one or more recipients who must be among those who respond affirmatively, weightings for responses from different recipients, a time limit by which responses must be received before the proposal is closed to the initial recipients, and so on. Selectable parameters may also include time commitments required for acceptors, such as 5 hours per week, 40 hours per week, nights and weekends, or other specified time contributions that acceptors much be able to commit to.

At S340, the method of FIG. 3 includes accepting selected parameter(s) and distributing the proposal to selected recipients. The proposal may be distributed via electronic communication networks to the selected users so that the proposal appears in their instantiations of the Conjungctio application on their user devices. The proposal may be provided as a selectable option that, when selected, fully displays a screen with the selectable parameters.

At S350, the method of FIG. 3 includes determining whether the required parameters have been met. Numerous different parameters may be selected as requirements to generate Node A, Node B or Node C as in FIG. 1.

For example, in some embodiments, the parameter options may include a requirement of affirmative answers from fewer than all of the second user devices. For example, the parameter options may require affirmative answers from three of eight user devices in the set of second user devices. Once three user devices in the set of second user devices have affirmatively answered, the smart contract application on the first user device may close the smart contract and notify the set of second set of user devices that the smart contract is closed. In another example, the parameter options may require affirmative answers from at least a particular combination of user devices, such as user devices used by different types of users. For example, a project may require acceptance of two or more oncologists and one or more chemist, and this may be specified in the proposal so that users are updated as requirements to start the project are met.

In some embodiments, different of the second user devices may be assigned different weightings, and a sum of affirmative answers may reflect different weights for different of the affirmative answers. For example, a user device U in the second set may be assigned a weighting of 2.25, and five other user devices V, W X, Y and Z in the second set may be assigned weightings of 0.75. If a required sum among the set of second user devices is 3, then the user device U combined with even just one of the five other user devices V, W, X, Y and Z may be enough to complete the smart contract by responding in the affirmative.

In some embodiments, a time limit for a number of required affirmative responses may be set as one of the required parameters. When the time limit passes without a number of required affirmative responses from the set of second user devices, new user devices may be added to the set of second user devices. For example, unselected user devices from a large pool from which the set of second user devices were originally selected may be added to the set of second user devices. User devices may be originally or subsequently added to the set of second user devices based on histories of the users of the user devices, such as involvement in prior smart contracts. Additionally, user devices from the original set of second user devices may be expelled when the time limit passes without an affirmative response from the user devices that are expelled. The user devices that are expelled may be replaced with the new user devices that are added. In some embodiments, user devices that are expelled from the set of second user devices may be locked out from the proposal for the smart contract. For example, even when additional user devices are added to the set of second user devices, the original user devices expelled from the set of second user devices may be banned from re-invitation.

If the parameters have not been met at S350 (S350=No), a delay between making the determination again occurs at S360. If the parameters have been met (S350=Yes), at S370 the method includes opening and displaying a proposal acceptance graphical user interface and notifying the recipients that the proposal has been accepted and the smart contract has been successfully completed. The proposal acceptance smart user interface may include information of recipients who accepted the proposal.

At S380, the smart contract is locked. That is, the smart contract is completed and the sender at the first user device and the affirmative recipients among the users of the set of second user devices are locked into the smart contract. For example, in some embodiments, the smart contract application may be installed on each of the first user device and the second user devices. The smart contract application may lock in a completed smart contract once the required parameters in the parameter options are met by the second user devices. For example, the smart contract may be closed to user devices among the set of second user devices that did not opt in. Additionally or alternatively, instantiations of the smart contract application installed on each of the first user device and the second user devices may interact to complete the smart contract automatically based on the proposal and the answers to the first proposal. For example, the second user devices may send responses to the proposal to the first user device, and the smart contract application on the first user device may process the responses and determine when the required parameters are met.

Although not shown in FIG. 3A, parties to a smart contract may also be evicted from a smart contract in accordance with the details of an original proposal. For example, if a party who agrees to a smart contract is successfully found not to perform their required duties, other parties in the smart contract may inform an administrator of the smart contract application that the non-performing party is not performing. As a result, a smart contract may provide for evicting one party based on non-performance. In other embodiments, if a party wishes to exit a smart contract, other parties in the smart contract may be enabled to bid for any tokens assigned to the existing party. Therefore, even partial performance in a smart contract may be rewarded and compensated at market prices.

In some embodiments, rules governing performance of smart contracts may be implemented system-wide across the smart contract application, and need not be detailed in every proposal. For example, mechanisms for evicting a party to a smart contract or for a party to voluntarily exist a smart contract may be defaults that can be automatically implemented by the smart contract application.

FIG. 3B illustrates another user interface for smart contract implementation mechanisms, in accordance with a representative embodiment.

In FIG. 3B, the user interface 335 shows a variety of parameters that may be selectably required for a proposal. The selectable parameters include a timer to set a time limit for the proposal, a required number of modes per acceptance, specific recipients that are individually required, a required number of acceptances and whether the required number of acceptances is a minimum or a total. The parameters shown in FIG. 3B for a proposal are only examples, and parameters required in order to complete a smart contract may vary from those shown in other embodiments.

Additionally, while the user interface in FIG. 3B is shown on the first user device which creates the proposal, the parameters selected by the user may also be sent to the users of the second user devices. For example, users of the second user devices may benefit from knowledge of how many affirmative responses are required in order to complete the smart contract. Additionally, while not shown in FIG. 3B, the users using the set of second user devices may also receive updates that show when others of the second user devices have responded negatively or affirmatively to the proposal.

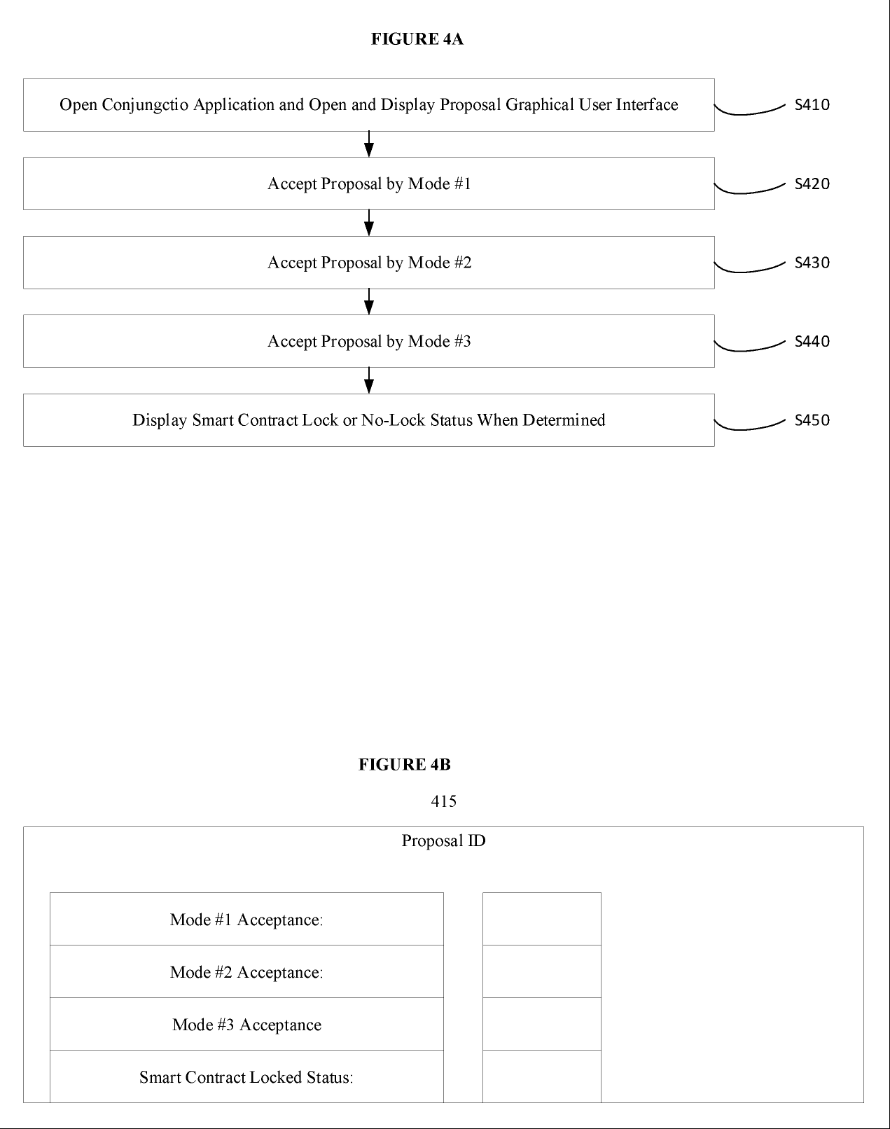

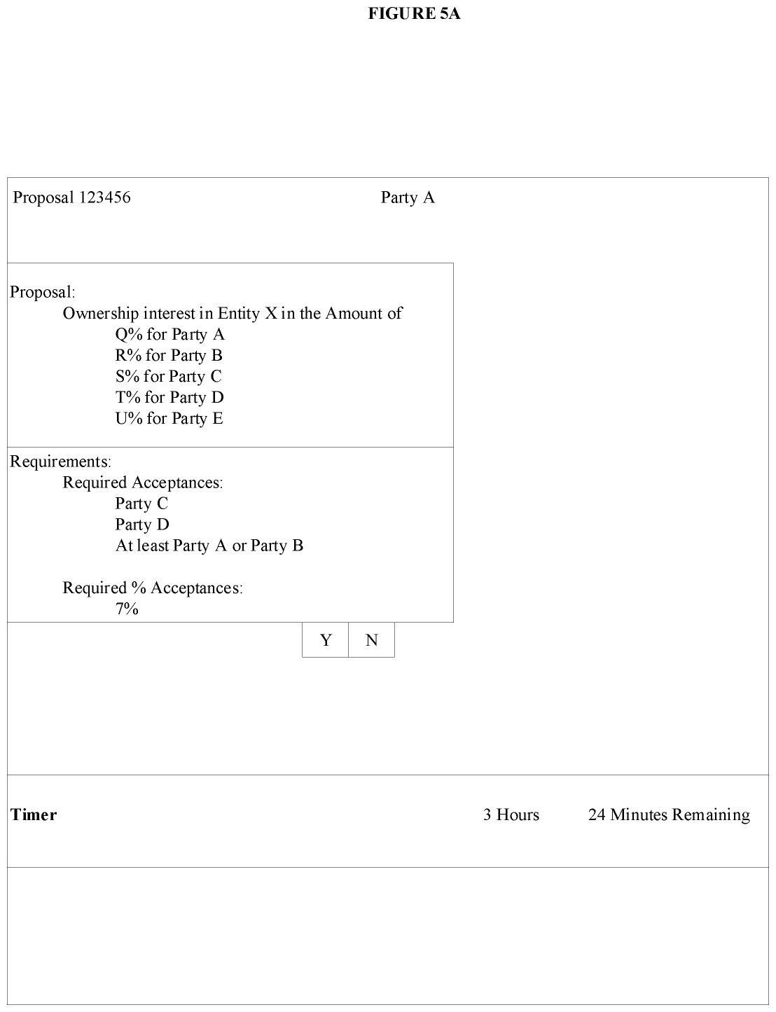

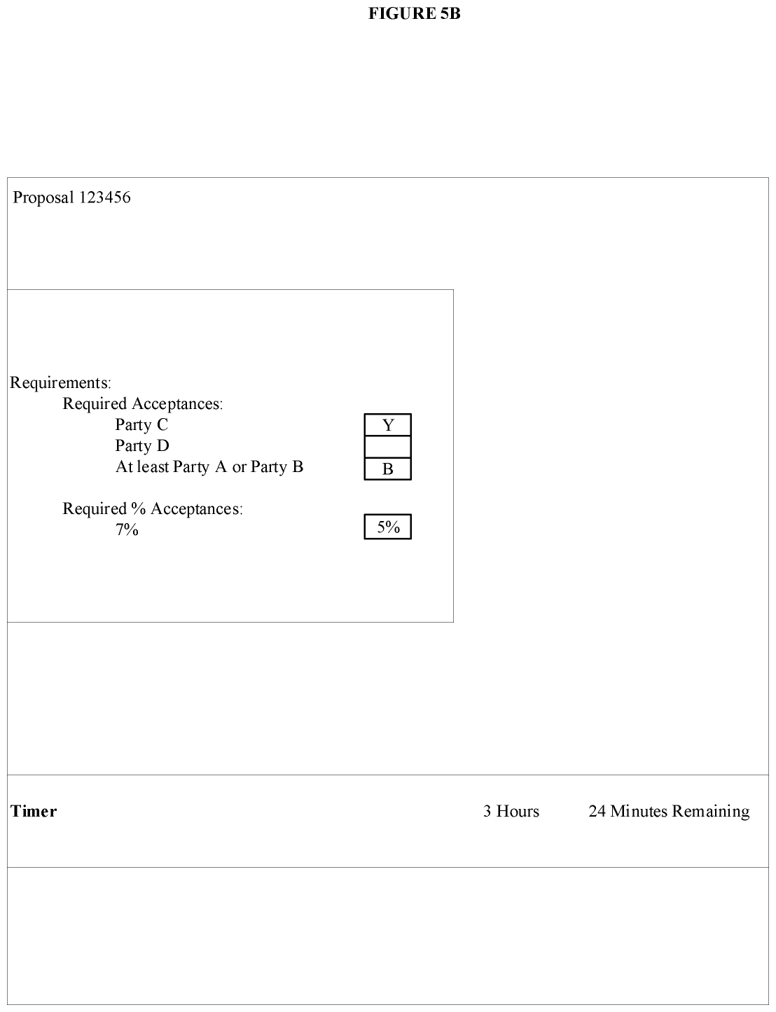

FIG. 4A illustrates another method for smart contract implementation mechanisms, in accordance with a representative embodiment.

The method in FIG. 4A starts at S410 with opening the Conjungctio smart contract application and opening and displaying a proposal graphical user interface. The Conjunction smart contract application may be opened on one of the set of second user devices at S410.

At S420, the proposal may be accepted by communication mode #1. At S430, the proposal may be accepted by communication mode #2. At S440, the proposal may be accepted by communication mode #3. Each acceptance of the proposal may be communicated to the first user device in the peer-to-peer network and tallied against the required parameters for the proposal.

At S450, the method in FIG. 4A includes displaying a smart contract lock or no-lock status when the lock or no-lock status is determined. As mentioned above, updated before the lock or no-lock status is determined may also be provided to the set of second user devices, such as when any response is received for a proposal from any of the set of second user devices.

Although not shown in FIG. 4A, proposals may be limited by wider factors tracked by the smart contract application. For example, individual user devices may be subject to a limit of proposals, such as a maximum number of proposals per day or per week. Individual user devices may also be subject to a limit on proposals once they have declined a particular number of proposals generally, proposals of a specific type or from a specific initiator, or other factors such as determinations of non-compliance with previous smart contracts.

FIG. 4B illustrates another user interface for smart contract implementation mechanisms, in accordance with a representative embodiment.

In FIG. 4B, the user interface 415 includes fields to indicate (e.g., via a checkbox) when acceptance of a proposal has been provided by mode #1, by mode #2 and/or by mode #3. The user interface 415 also includes fields to indicate when the smart contract is locked based on the required parameters being met.

FIG. 5A illustrates a user interface for a recipient of a proposal in smart contract implementation mechanisms, in accordance with a representative embodiment.

As shown in FIG. 5A, a user interface received by a recipient of a proposal shows a proposal identification number and the recipient identification (Party A) at the top. A Proposal field shows the details of the proposal including the proposal for Party A, as well as the details of the proposal for other recipients. A Requirements field shows the requirements that must be met for the smart contract to be implemented. As shown, the requirements include acceptance by Party C, acceptance by Party D, and acceptance by at least Party A or Party B. The requirements also include acceptances amounting to at least 7%. At the bottom, a timer shows the amount of time remaining for the smart contract to be completed as 3 hours and 24 minutes.

Additionally, the user interface in FIG. 5A shows selectable options for Yes and No for the recipient (Party A) to select an answer to the proposal. Each different recipient of the proposal is provided with a user interface similar to that shown in FIG. 5A for Party A. Each different recipient is provided an ability to selectively agree to the proposal or not agree to the proposal. The user interface in FIG. 5A may also show a running total as Party A and other recipients respond to the Proposal.

Accordingly, a recipient of a proposal such as Party A may be provided with the details pertinent specifically to the recipient as well as details specific to other recipients. The recipient may also be provided with requirements that must be met by specific recipients as well as by the overall set of second user devices corresponding to the overall group of recipients.

Although not shown in FIG. 5A, in some embodiments any second user devices that accept a proposal for a smart contract may be made eligible for a proposal for a new smart contract based on accepting the proposal for the smart contract. Second user devices that do not accept the proposal for the smart contract may be made ineligible for the proposal for the new smart contract. For example, a subsequent smart contract proposal from the first user device may be proposed to the eligible second user devices but not to the ineligible second user devices. Therefore, engagement in activities with the smart contract application may be a predicate for being offered opportunities to engage in other activities with the smart contract application. Therefore, a method for implementing smart contracts may involve implementing multiple smart contracts in a manner in which participation in a first smart contract serves as a predicate enabling eligibility for receiving a proposal for a subsequent second smart contract.

In some embodiments, a smart contract application installed on a third user device may generate the proposal for the subsequent smart contract. Therefore, the originator of the proposal in FIG. 5A is not necessarily the originator of a subsequent proposal that is made accessible to recipients based on participation in the smart contract of FIG. 5A. A set of parameter options for completing the new smart contract may be generated and displayed via the third user device in the same manner as a set of parameter options shown for the proposal in FIG. 5A. The third user device may transmit the subsequent proposal for the smart contract to a set of fourth user devices specified by the parameter options. The fourth user devices may, but do not have to, partially or fully overlap with the second user devices that receive the proposal from the first user device in FIG. 5A.

Although not shown in FIG. 5A, other requirements may be imposed on a proposal, such as a maximum number of affirmative responses allowed. For example, a proposal may be sent to 100 recipients, and the smart contract may be completed once 25 of the 100 recipients respond affirmatively. In some embodiments, the potential recipients of a proposal presented to an initiator of the proposal may be limited based on factors such as previous participation, ratings of the potential recipients by other users of the smart contract application, and other factors.

FIG. 5B illustrates a user interface for an originator of a proposal in smart contract implementation mechanisms, in accordance with a representative embodiment.

As shown in FIG. 5B, the user interface shows the originator that Party C and Party B have accepted the proposal, but that Party D has not yet accepted as one of the specific individuals required to accept the proposal for the smart contract to lock. Additionally, the user interface shows the originator that only 5% of the required 7% of acceptances have affirmatively responded to the proposal. Accordingly, the smart contract being monitored using the user interface in FIG. 5B has not yet completed.

Accordingly, FIG. 5A shows an example of a user interface presented to a recipient of a proposal using the smart contract application, and FIG. 5B shows an example of a user interface presented to an originator of a proposal using the smart contract application. The user interfaces in FIG. 5A and in FIG. 5B are only examples, and the subject of proposals that can be implemented using smart contract implementation mechanisms is not limited to business proposals as shown in FIG. 5A and in FIG. 5B.

FIG. 6 illustrates a computer system, on which a method for implementing smart contract implementation mechanisms is implemented, in accordance with a representative embodiment.

The computer system 600 of FIG. 6 shows a complete set of components for a communications device or a computer device. However, a “computer” as described herein may be implemented with less than the set of components of FIG. 6, such as by at least a memory and processor combination. The computer system 600 may include some or all elements of one or more component apparatuses in a system for blockchain-based transaction mechanisms herein, although any such apparatus may not necessarily include one or more of the elements described for the computer system 600 and may include other elements not described.

Referring to FIG. 6, the computer system 600 includes a set of software instructions that can be executed to cause the computer system 600 to perform any of the methods or computer-based functions disclosed herein. The computer system 600 may operate as a standalone device or may be connected, for example, using a network 601, to other computer systems or peripheral devices. In embodiments, a computer system 600 performs logical processing based on digital signals received via an analog-to-digital converter.

In a networked deployment, the computer system 600 operates in the capacity of a server or as a client user computer in a server-client user network environment, or as a peer computer system in a peer-to-peer (or distributed) network environment. The computer system 600 can also be implemented as or incorporated into various devices, such as a computer at any user device or blockchain transaction node described herein, a server, a stationary computer, a mobile computer, a personal computer (PC), a laptop computer, a tablet computer, or any other machine capable of executing a set of software instructions (sequential or otherwise) that specify actions to be taken by that machine. The computer system 600 can be incorporated as or in a device that in turn is in an integrated system that includes additional devices. In an embodiment, the computer system 600 can be implemented using electronic devices that provide voice, video or data communication. Further, while the computer system 600 is illustrated in the singular, the term “system” shall also be taken to include any collection of systems or sub-systems that individually or jointly execute a set, or multiple sets, of software instructions to perform one or more computer functions.

As illustrated in FIG. 6, the computer system 600 includes a processor 610. The processor 610 is tangible and non-transitory. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The processor 610 is an article of manufacture and/or a machine component. The processor 610 is configured to execute software instructions to perform functions as described in the various embodiments herein. The processor 610 may be a general-purpose processor or may be part of an application specific integrated circuit (ASIC). The processor 610 may also be a microprocessor, a microcomputer, a processor chip, a controller, a microcontroller, a digital signal processor (DSP), a state machine, or a programmable logic device. The processor 610 may also be a logical circuit, including a programmable gate array (PGA), such as a field programmable gate array (FPGA), or another type of circuit that includes discrete gate and/or transistor logic. The processor 610 may be a central processing unit (CPU), a graphics processing unit (GPU), or both. Additionally, any processor described herein may include multiple processors, parallel processors, or both. Multiple processors may be included in, or coupled to, a single device or multiple devices.

The term “processor” as used herein encompasses an electronic component able to execute a program or machine executable instruction. References to a computing device comprising “a processor” should be interpreted to include more than one processor or processing core, as in a multi-core processor. A processor may also refer to a collection of processors within a single computer system or distributed among multiple computer systems. The term computing device should also be interpreted to include a collection or network of computing devices each including a processor or processors. Programs have software instructions performed by one or multiple processors that may be within the same computing device or which may be distributed across multiple computing devices.

The computer system 600 further includes a main memory 620 and a static memory 630, where memories in the computer system 600 communicate with each other and the processor 610 via a bus 608. Memories described herein are tangible storage mediums for storing data and executable software instructions and are non-transitory during the time software instructions are stored therein. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The main memory 620 and the static memory 630 are articles of manufacture and/or machine components. The main memory 620 and the static memory 630 are computer-readable mediums from which data and executable software instructions can be read by a computer (e.g., the processor 610). Each of the main memory 620 and the static memory 630 may be implemented as one or more of random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. The memories may be volatile or non-volatile, secure and/or encrypted, unsecure and/or unencrypted.

“Memory” is an example of a computer-readable storage medium. Computer memory is any memory which is directly accessible to a processor. Examples of computer memory include, but are not limited to RAM memory, registers, and register files. References to “computer memory” or “memory” should be interpreted as possibly being multiple memories. The memory may for instance be multiple memories within the same computer system. The memory may also be multiple memories distributed amongst multiple computer systems or computing devices.

As shown, the computer system 600 further includes a video display unit 650, such as a liquid crystal display (LCD), an organic light emitting diode (OLED), a flat panel display, a solid-state display, or a cathode ray tube (CRT), for example. Additionally, the computer system 600 includes an input device 660, such as a keyboard/virtual keyboard or touch-sensitive input screen or speech input with speech recognition, and a cursor control device 670, such as a mouse or touch-sensitive input screen or pad. The computer system 600 also optionally includes a disk drive unit 680, a signal generation device 690, such as a speaker or remote control, and/or a network interface device 640.

In an embodiment, as depicted in FIG. 6, the disk drive unit 680 includes a computer-readable medium 682 in which one or more sets of software instructions 684 (software) are embedded. The sets of software instructions 684 are read from the computer-readable medium 682 to be executed by the processor 610. Further, the software instructions 684, when executed by the processor 610, perform one or more steps of the methods and processes as described herein. In an embodiment, the software instructions 684 reside all or in part within the main memory 620, the static memory 630 and/or the processor 610 during execution by the computer system 600. Further, the computer-readable medium 682 may include software instructions 684 or receive and execute software instructions 684 responsive to a propagated signal, so that a device connected to a network 601 communicates voice, video or data over the network 601. The software instructions 684 may be transmitted or received over the network 601 via the network interface device 640.

In an embodiment, dedicated hardware implementations, such as application-specific integrated circuits (ASICs), field programmable gate arrays (FPGAs), programmable logic arrays and other hardware components, are constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing may implement one or more of the methods or functionalities as described herein, and a processor described herein may be used to support a virtual processing environment.

FIG. 7 illustrates a network for implementing smart contract implementation mechanisms, in accordance with a representative embodiment.

In FIG. 7, a first user electronic communication device 701 communicates via a server 710 with a second user electronic communication device 721 and a third user electronic communication device 722. Each of the first user electronic communication device 701, the second user electronic communication device 721 and the third user electronic communication device 722 may include components shown in and described with respect to the computer system 600 in FIG. 6. Additionally, the server 710 may include components shown in and described with respect to the computer system 600 in FIG. 6.

The first user electronic communication device 701 may be representative of a device on which an application is installed to create a smart contract. The second user electronic communication device 721 and the third user electronic communication device 722 are representative of a pool of devices on which the application is installed and which can receive a proposal to engage in the smart contract and to accept engagement in the smart contract, as described herein. The server 710 may coordinate and track different user electronic devices to coordinate which users and user electronic devices are engaged in which smart contracts implemented using the application.

As described herein, uses of smart contract implementation mechanisms are not limited to implementing business contracts and/or serving as the basis for generating electronic tokens. Rather, smart contract implementation mechanisms can be used in a variety of other contexts. For example, if an owner of a business wants to distribute equity in the business to employees, the owner can use smart contract implementation mechanisms to arrange for the employees to agree to receive their share of the equity in the form of electronic tokens. An owner may, for example, send a proposal for 1000 employees to each receive 1/100th of 1% of the equity in the business, and employees who respond within a set deadline may take part in the completed smart contract. In another example, a will may be executed by an executor using smart contract implementation mechanisms to arrange for the beneficiaries to agree to receive their share of the distributions in the form of electronic tokens. The executor may, for example, send a proposal for 12 family members to each receive individualized shares of distributions

Accordingly, smart contract implementation mechanisms enables a set of user devices to implement a smart contract on an application installed on the set of user devices. The smart contract may be between more than two people, and may be fully known to multiple parties engaged in the smart contract. The smart contract implementations described herein can be tracked and aggregated over time so that trust can be developed among the users of the user devices. For example, users may develop a history of agreeing to small commitments via the smart contracts, and then may develop patterns of trust for which users honor their commitments. The levels of trust may be reflected in many ways, including by being offered opportunities to engage in more, better and/or different types of smart contracts involving other users.

Although smart contract implementation mechanisms has been described with reference to several exemplary embodiments, it is understood that the words that have been used are words of description and illustration, rather than words of limitation. Changes may be made within the purview of the appended claims, as presently stated and as amended, without departing from the scope and spirit of smart contract implementation mechanisms in its aspects. Although smart contract implementation mechanisms smart contract implementation mechanisms has been described with reference to particular means, materials and embodiments, smart contract implementation mechanisms is not intended to be limited to the particulars disclosed; rather smart contract implementation mechanisms extends to all functionally equivalent structures, methods, and uses such as are within the scope of the appended claims.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to practice the concepts described in the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. A method for completing a smart contract, comprising:
generating, by a smart contract application installed on a first user device, a proposal for a smart contract;
creating a set of parameter options for completing the smart contract, and displaying the set of parameter options via the first user device;
transmitting, by the first user device, the proposal for the smart contract to a set of second user devices specified by the parameter options; and
only when required parameters in the parameter options are met, completing the smart contract by the smart contract application installed on the first user device, and notifying each of the second user devices.

2. The method of claim 1, wherein creating a set of parameter options comprises:
providing optional requirements for different modes of communication, different communication devices, and different accounts for recipients at different ones of the second user devices.

3. The method of claim 1, wherein the smart contract is automatically completed without further instructions from a user of the first user device after the set of parameter options are completed.

4. The method of claim 1, wherein the parameter options include a requirement of affirmative answers from fewer than all of the second user devices.

5. The method of claim 4, wherein different of the second user devices are assigned different weightings, and a sum of affirmative answers reflects different weights for different of the affirmative answers.

6. The method of claim 4, wherein recipients corresponding to different of the second user devices are assigned different weightings, and a sum of affirmative answers reflects different weights for different of the affirmative answers.

7. The method of claim 1,
wherein the smart contract application is installed on each of the first user device and the second user devices, and
wherein the smart contract application is configured to lock in a completed smart contract once the required parameters in the parameter options are met by the second user devices.

8. The method of claim 1,
wherein the smart contract application is installed on each of the first user device and the second user devices, and
instantiations of the smart contract application installed on each of the first user device and the second user devices interact to complete the smart contract automatically based on the proposal and answers to the first proposal.

9. The method of claim 1, further comprising:
setting a time limit for a number of required affirmative responses as one of the required parameters, and
adding new user devices to the set of second user devices when the time limit passes without the number of required affirmative responses.

10. The method of claim 9, further comprising:
expelling user devices from the set of second user devices when the time limit passes without an affirmative response from the user devices that are expelled; and
replacing the user devices that are expelled with the new user devices that are added.

11. The method of claim 10, further comprising:
locking out the user devices that are expelled from the set of second user devices from the proposal for the smart contract.

12. The method of claim 1, further comprising:
limiting a number of affirmative responses that are accepted as one of the required parameters.

13. The method of claim 1, wherein the first user device and the second user devices communicate in a peer-to-peer network via the smart contract application.

14. The method of claim 1, wherein the first user device and the second user devices communicate in a plurality of communication modes.

15. The method of claim 1, further comprising:
making second user devices that accept the proposal for the smart contract eligible for a proposal for a new smart contract, and
making second user devices that do not accept the proposal for the smart contract ineligible for the proposal for the new smart contract.

16. The method of claim 15, further comprising:
generating, by the smart contract application installed on a third user device, the proposal for the smart contract;
creating a set of parameter options for completing the new smart contract, and displaying the set of parameter options via the third user device;
transmitting, by the third user device, the proposal for the smart contract to a set of fourth user devices specified by the parameter options.

17. A method for completing multiple smart contracts, comprising:
generating, by a smart contract application installed on a first user device, a first proposal for a first smart contract;
creating a first set of parameter options for completing the first smart contract, and displaying the first set of parameter options via the first user device;
transmitting, by the first user device, the first proposal for the first smart contract to a set of second user devices specified by the first set of parameter options;
only when required parameters in the first set of parameter options are met, completing the first smart contract by the smart contract application installed on the first user device, and notifying each of the second user devices
generating, by a smart contract application installed on a third user device, a second proposal for a second smart contract;
creating a second set of parameter options for completing the second smart contract, and displaying the second set of parameter options via the third user device;
transmitting, by the third user device, the second proposal for the second smart contract to a set of fourth user devices specified by the second set of parameter options;
only when required parameters in the second set of parameter options are met, completing the second smart contract by the smart contract application installed on the third user device, and notifying each of the fourth user devices.

18. The method of claim 17, wherein the first set of parameter options differs from the second set of parameter options.

19. The method of claim 18, wherein the first set of parameter options overlaps with the second set of parameter options.

20. The method of claim 17, wherein a combination of the first user device and the second user devices overlaps with a combination of the third user device and the fourth user devices.
